(19) United States
(12) Patent Application Publication
(10) Pub. No.: US 2022/0302997 A1
(43) Pub. Date: Sep. 22, 2022

(54) INTELLIGENT ROAMING FOR MOBILE AND NOMADIC COMMUNICATIONS SYSTEMS ARCHITECTURE AND METHODS

(71) Applicant: Envistacom, LLC, Atlanta, GA (US)

(72) Inventors: Michael BEELER, Jefferson, MD (US); Michael GEIST, Huntersville, NC (US); Cris MAMARIL, Mesa, AZ (US); Roy AXFORD, San Diego, CA (US); Richard DAVIS, Bel Air, MD (US)

(21) Appl. No.: 17/692,894

(22) Filed: Mar. 11, 2022

Related U.S. Application Data
(60) Provisional application No. 63/162,899, filed on Mar. 18, 2021.

(51) Int. Cl. H04B 7/185; G06N 5/02

(52) U.S. Cl. CPC H04B 7/18517; H04B 7/18504; G06N 5/022

(57) ABSTRACT

Provided is a communication network comprising a ground station, comprising a modem communicatively coupled to at least one aerial or space communications platform communicatively coupled to at least one communications terminal system, comprising an HPC-based satellite modem configured with machine learning capability for optimization of communications network connections.

### CROSS-REFERENCE TO RELATED PATENT APPLICATIONS

This patent application claims priority to U.S. Provisional Patent Application No. 63/162,899, filed Mar. 18, 2021, the disclosure of which is herein incorporated in its entirety.

### FIELD OF THE INVENTION

This disclosure relates to a communication network comprising a ground station comprising a modem communicatively coupled to at least one aerial or space communications platform communicatively coupled to at least one communications terminal system comprises a high-performance computer (HPC)-based satellite modem configured with machine learning capability, a terminal with access to a plurality of repeating relays, a terminal with access to a plurality of regenerative relays with on-board processing, a terminal with a directional antenna requiring pointing to at least one aerial or space communications platform for connectivity.

### BACKGROUND OF THE INVENTION

Satellite communication (SATCOM) and terrestrial microwave communication systems, e.g., cellular, and tactical networking, typically require the use of transmitter/receivers connected to directional antennas that aim the energy of a signal in either a general or specific direction towards another directional antenna connected to a transmitter/receiver. A common type of antenna used in both SATCOM and terrestrial communications is a directional Yagi (for lower frequencies) or parabolic reflector (for higher frequencies above two (2) GHz) with a waveguide feed located at the focal point of the parabola. These antennas are highly effective in networks where both the antenna and the distant end antenna are stationary, such as in the case of a Geosynchronous Earth Orbit (GEO) satellite, operating approximately 35,786 km above the Earth, or a microwave point-to-point link between two buildings or a building and a tower where there is no or extremely limited movement of both the transmission terminal as well as the satellite.

New satellite technologies have opened new access to Satellite Communications (SATCOM), where mobile antennas are becoming manufactured more inexpensively, resulting in the ability to produce an antenna that is nearing consumer grade operation for both mobile as well as nomadic use. Recently, with the introduction of Medium-Earth Orbit (MEO), operating approximately between 5,000 to 12,000 km above the Earth, and Low-Earth Orbit (LEO) satellite capabilities, operating approximately between 500 to 1,600 km above the Earth, with the deployment of new satellite constellations for MEO, O3B (Other 3 Billion), and for LEO: OneWeb, Starlink, Telesat, and Kuiper, the ability to have a low-earth orbit, but non-geosynchronous satellite is becoming commonplace.

This rapid pace of technology change is a huge deviation from the industry norm, where monolithic purpose-built proprietary hardware and waveforms predominate. These rigid solutions for fixed base operation as well as fixed satellite orbits, offered by GEO satellites, currently dominating SATCOM ecosystems are not suitable for a rapidly changing environment. There exists a need in the art for an integrated, flexible, and adaptable system to maximize the capabilities of SATCOM.

### SUMMARY OF VARIOUS EMBODIMENTS OF THE INVENTION

In an embodiment, a communication network may comprise a ground station comprising a modem communicatively coupled to at least one communications platform communicatively coupled to at least one communications terminal system comprising a high-performance computer (HPC)-based satellite modem configured with machine learning capability, configured with access to a plurality of repeating relays, regenerative relays with on-board processing, or a combination thereof, and coupled to a directional antenna requiring pointing to at least one aerial or space communications platform for connectivity. The communications terminal system may be a fixed terminal, Communications on the Move (COTM) system, Communication on the Pause (COTP), or a combination thereof. The communications terminal system may further comprise a terminal with a plurality of input parameters to enable decisions to be made based on an initial starting location.

In an embodiment, the ground station may comprise a ground station for receiving communications from a repeating relay from one or a plurality of repeating relays. The ground station may comprise a ground station for receiving communications from a regenerative relay with on-board processing from one or more regenerative relays with on-board processing. The ground station may comprise a ground station for receiving communications from a regenerative relay with on-board processing, repeating relay, or a combination thereof, from one or more regenerative relays with on-board processing, one or more repeating relay, or a combination thereof.

In an embodiment, the communications platform may be an aerial communications platform, space communications platform, or a combination thereof. The space communications platform may be a LEO satellite gateway, GEO satellite gateway, or MEO satellite gateway acting as a communications end point or a communications relay. The aerial communications platform may comprise a satellite, airplane, balloon, drones, helicopters, airships (zeppelins), rockets, and combinations thereof, acting as a communications end point or a communications relay.

In an embodiment, the communications terminal system may be configured to process a plurality of input parameters to enable decisions to be made based on an initial starting location of the communications platform.

In an embodiment, the communications terminal system may be a fixed terminal.

In an embodiment, the communications on the move (COTM) may comprise a vehicle, a HPC-based satellite modem configured with machine learning capability, an antenna, and may be mobile. In an embodiment, the communication on the pause (COTP) system may comprise a vehicle, a HPC-based satellite modem configured with machine learning capability, an antenna, and may be mobile. The vehicle may be a surface vehicle, an airborne vehicle, or submersible vehicle.

In an embodiment, the machine learning capability may comprise a machine learning system.

The machine learning system may be trained using historic data.

In an embodiment, the machine learning system may comprise a high-performance computer existing as a central processing unit and combined with a hardware acceleration device, while operating in a heterogeneous fashion.

In an embodiment, the machine learning system may be configured to access and/or process data from static databases, dynamic databases, and combinations thereof.

In an embodiment, the machine learning system may be configured to access and/or process data comprising weather data, terrain data, video data, geographic data, traffic data, satellite cost data, crowd-sourced data, signal strength, satellite positions, cost of satellite service, transmission times, obstructions to communications, wavelengths, and combinations thereof.

In an embodiment, the machine learning system may be configured to access and/or process data dynamic data, optionally updated in real-time, and static data, optionally sporadically updated.

In an embodiment, the machine learning system may be configured to access and/or process data stored on public databases, private databases, databases managed by government agencies, and combinations thereof.

In an embodiment, the machine learning system may use an algorithm selected from the group consisting of linear regression, logistic regression, decision tree, support vector machine (SVM), Naïve Bayes, k-nearest neighbors (kNN), K-means, Random Forest, Dimensionality Reduction Algorithms, Gradient Boosting algorithms, or an ensemble thereof. The Gradient Boosting algorithm may be gradient boosting machine (GBM), extreme gradient boost (XGBoost), LightGBM, CatBoost, or an ensemble thereof.

In an embodiment, the machine learning system may be a reinforcement learning system.

In an embodiment, the machine learning system, optionally a reinforcement learning system, may use an algorithm selected from the group consisting of a Monte Carlo algorithm, Q-learning algorithm, State-action-reward-state-action (SARSA) algorithm, Q-learning—lambda algorithm, SARSA-lambda algorithm, DQN (Deep Q Network) algorithm, DDPG (Deep Deterministic Policy Gradient) algorithm, A3C (Asynchronous Advantage Actor-Critic Algorithm) algorithm, NAF (Q-learning with normalized Advantage functions) algorithm, TRPO (Trust Region Policy Optimization) algorithm, PPO (Proximal Policy Optimization) algorithm, TD3 (twin delayed deep deterministic policy gradient) algorithm, SAC (Soft Actor-Critic) algorithm, or an ensemble thereof.

In an embodiment, the machine learning system, optionally a reinforcement learning system, may be trained on data from static databases, dynamic databases, and combinations thereof.

In an embodiment, the machine learning system, optionally a reinforcement learning system, may be trained on data comprising weather data, terrain data, video data, geographic data, traffic data, satellite cost data, crowd-sourced data, signal strength, satellite positions, cost of satellite service, transmission times, obstructions to communications, wavelengths, and combinations thereof.

In an embodiment, the machine learning system, optionally a reinforcement learning system, may be trained on data comprising dynamic data, optionally updated in real-time, and static data, optionally sporadically updated.

In an embodiment, the machine learning system, optionally a reinforcement learning system, may be trained on data stored on public databases, private databases, databases managed by government agencies, and combinations thereof.

In an embodiment, a method is provided for optimizing a communication network comprising accessing data at a communications terminal system comprising a high-performance computer (HPC)-based satellite modem configured with machine learning capability, processing the data using a machine learning system, and generating a recommendation for configuration of a communications network.

In an embodiment, the communications terminal system further may comprise access to a plurality of repeating relays and a directional antenna requiring pointing to at least one communications platform for connectivity. The communications terminal system further may comprise access to a plurality of regenerative relays with on-board processing and a directional antenna requiring pointing to at least one communications platform for connectivity. The communications terminal system further may comprise access to a plurality of repeating relays, regenerative relays with on-board processing, or a combination thereof, and a directional antenna requiring pointing to at least one communications platform for connectivity.

In an embodiment, a method for sending a message via a communications network comprising receiving a message at a ground station comprising a modem communicatively coupled to at least one communications platform communicatively coupled to at least one communications terminal system comprising a high-performance computer (HPC)-based satellite modem configured with machine learning capability, configured with access to a plurality of repeating relays, regenerative relays with on-board processing, or a combination thereof, and coupled to a directional antenna requiring pointing to at least one aerial or space communications platform for connectivity, determining a communications network for the message comprising accessing data the communications terminal system comprising a high-performance computer (HPC)-based satellite modem configured with machine learning capability, processing the data using a machine learning system, and generating a recommendation for configuration of a communications network, sending the message across the recommended communications network configuration.

In an embodiment, the communications terminal system may process a plurality of input parameters to enable decisions to be made based on an initial starting location of the communications platform. The communications terminal system may be configured to make a recommendation on configuration of the communication network to optimize communications. The communications terminal system may further be configured to execute a recommendation to reconfigure the communications network to optimize communications.

In an embodiment, the method may further comprise generating a further network configuration recommendation and reconfiguring the communications network based on the further recommendation.

In an embodiment, the machine learning system may be trained using historic data. The machine learning system may be trained using historic data, current data, or a combination thereof. The current data may be accessed from static databases, dynamic databases, or a combination thereof. The machine learning system may be trained using heterogeneous data including but not limited to signal strength, demand for satellite service, weather data, terrain data, video data, geographic data, traffic data, satellite cost data, crowd-sourced data, signal strength, satellite positions, cost of satellite service, transmission times, obstructions to communications, wavelengths, and combinations thereof.

In an embodiment, the machine learning system may access and/or process data from static databases, dynamic databases, and combinations thereof.

In an embodiment, the machine learning system may access and/or process data comprising weather data, terrain data, video data, geographic data, traffic data, satellite cost data, signal strength, satellite positions, cost of satellite service, transmission times, obstructions to communications, wavelengths, and combinations thereof.

In an embodiment, the machine learning system may access and/or process dynamic data, optionally updated in real-time, and static data, optionally sporadically updated.

In an embodiment, the machine learning system may access and/or process data stored on public databases, private databases, databases managed by government agencies, and combinations thereof.

In an embodiment, the machine learning system may use an algorithm selected from the group consisting of linear regression, logistic regression, decision tree, support vector machine (SVM), Naïve Bayes, k-nearest neighbors (kNN), K-means, Random Forest, Dimensionality Reduction Algorithms, Gradient Boosting algorithms, or an ensemble thereof. The Gradient Boosting algorithm may be gradient boosting machine (GBM), extreme gradient boost (XGBoost), LightGBM, CatBoost, or an ensemble thereof.

In an embodiment, the machine learning system may be a reinforcement learning system.

In an embodiment, the machine learning system, optionally a reinforcement learning system, may use an algorithm selected from the group consisting of a Monte Carlo algorithm, Q-learning algorithm, state-action-reward-state-action (SARSA) algorithm, Q-learning—lambda algorithm, SARSA-lambda algorithm, DQN (Deep Q Network) algorithm, DDPG (Deep Deterministic Policy Gradient) algorithm, A3C (Asynchronous Advantage Actor-Critic Algorithm) algorithm, NAF (Q-learning with normalized Advantage functions) algorithm, TRPO (Trust Region Policy Optimization) algorithm, PPO (Proximal Policy Optimization) algorithm, TD3 (twin delayed deep deterministic policy gradient) algorithm, SAC (Soft Actor-Critic) algorithm, or an ensemble thereof.

In an embodiment, the machine learning system, optionally a reinforcement learning system, may be trained on data from static databases, dynamic databases, and combinations thereof.

In an embodiment, the machine learning system, optionally a reinforcement learning system, may be trained on data comprising weather data, terrain data, video data, geographic data, traffic data, satellite cost data, crowd-sourced data, signal strength, satellite positions, cost of satellite service, transmission times, obstructions to communications, wavelengths, and combinations thereof.

In an embodiment, the machine learning system, optionally a reinforcement learning system, may be trained on data comprising dynamic data, optionally updated in real-time, and static data, optionally sporadically updated.

In an embodiment, the machine learning system, optionally a reinforcement learning system, may be trained on data stored on public databases, private databases, databases managed by government agencies, and combinations thereof.

### BRIEF DESCRIPTION OF THE DRAWINGS

The advantages and features of the present invention will become better understood with reference to the following more detailed description taken in conjunction with the accompanying drawings.

FIG. 1 depicts an overview of an exemplary system comprising a fixed satellite terminal communicatively coupled to a fixed orbit GEO satellite.

FIG. 2 depicts an overview of an exemplary system comprising a Communications on the Move (COTM) terminal communicatively coupled to a GEO Satellite.

FIG. 3 depicts an overview of exemplary hardware architecture comprising using a single file or combination of files for supporting the roaming of a network based on the location of the COTM terminal on or over the earth.

FIG. 4 depicts an exemplary configuration of hardware architecture to support the accompanying virtualization architecture based on a high-performance computer (HPC) with the associated Edge Device.

FIG. 5 depicts an exemplary configuration of the network comprising a file (or multiple files) to enter a network and utilizing the systems and methods described herein for operation with GEO fixed satellites.

FIG. 6 depicts an exemplary configuration of the network comprising a file (or multiple files) to enter a network and utilizing the systems and methods described herein for operation with GEO fixed satellites and LEO moving satellites.

FIG. 7 depicts an exemplary implementation of infrastructure described herein with a plurality of inputs as decision points into a given network.

FIG. 8 depicts an exemplary implementation of infrastructure described herein as a flow diagram for initial entry into a given network.

FIG. 9 depicts an exemplary implementation of a weather event occurring in the path of the primary transmission path and an alternate, less optimal path with higher overall performance.

FIG. 10 depicts an exemplary implementation of a blockage event occurring in the path of the primary transmission path and an alternate, less optimal path with higher overall performance.

### DETAILED DESCRIPTION OF PREFERRED EMBODIMENTS

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only and is not intended to limit the scope of the present invention, which is limited only by the appended claims.

### Definitions

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

“Antenna Control Unit (ACU),” as used herein refers broadly to a unit that utilizes the resulting difference signal to select the optimum signal strength for the particular step of the search pattern. An antenna tracking system tracks a primary antenna to follow a moving signal source, such as a communication satellite. A secondary antenna has a greater beam width than the primary antenna and receives the same tracking signal from the satellite. The primary antenna is tracked according to a predetermined search pattern which causes a variation in the signal amplitude depending upon the relative location of the satellite and the antenna position. The signal strength signals from a primary antenna and a secondary antenna used to track a moving signal source (e.g., communication satellite) are input to a summation function which takes the difference of the two signals. The noise and signal variation component of the two signals is substantially the same and is therefore eliminated from the resulting difference signal. An antenna control unit utilizes the resulting difference signal to select the optimum signal strength for the particular step of the search pattern. This system is applicable from directional UHF to optical communications platform, which are subject to atmospheric distortion and noise.

“Baseband Modem,” as used herein, refers broadly to a digital modem that may be used to inter-connect computers, terminals, controllers and similar digital equipment over distances of up to 16 kms (10 miles) for LAN interconnection, campus networking, or high speed leased line internet links, over a single, un-conditioned twisted copper pair (two wires). These devices overcome distance limitation and noise problems by using special modulation and line equalization techniques and allow error-free communication over longer distances, at much higher data rates than conventional analog dial-up modems.

“Digital signal processing (DSP),” as used herein, refers broadly to techniques for improving the accuracy and reliability of digital communications. DSP may work by clarifying, or standardizing, the levels or states of a digital signal.

“Dynamic data,” as used herein, refers broadly to data that is updated in real time and made available across multiple databases. Dynamic data may be stored in remote databases, e.g., cloud-based databases, and rapidly accessed in real-time.

“Edge Device (ED),” as used herein, refers broadly to a device that controls data flow at the boundary between two networks. Some common functions performed by an edge device include, but are not limited to, transmission, routing, processing, monitoring, filtering, translation, and storage of data passing between networks.

“Geosynchronous Equatorial Orbit (GEO),” as used herein, refers broadly to a circular geosynchronous orbit approximately 35,786 km above the Earth's equator and following the direction of the Earth's rotation.

“High Performance Computer (HPC),” as used herein, refers broadly to a Central Processing Unit (CPU) with hardware acceleration. Generally, systems configured with HPC capability have the ability to process data and perform complex calculations at high speeds.

“Interface standard (IS),” as used herein, refers broadly to a standard that describes one or more functional characteristics (such as code conversion, line assignments, or protocol compliance) or physical characteristics (such as electrical, mechanical, or optical characteristics) necessary to allow the exchange of information between two or more (usually different) systems or pieces of equipment. Communications protocols are an example. For example, a method based on multi-layer encryption routing to obfuscate user identity, source/destination IP addresses, location and to provide multi-layer encryption to provide anonymity and protect the network from traffic analysis and eavesdropping is described in U.S. patent application Ser. No. 16/600,258.

“Library (LIB),” as used herein, refers broadly to the collection of satellite information in the form of beam maps, ephemeris data to include the time of orbital location path/direction of satellite, and other information.

“Machine Learning (ML),” as used herein, refers broadly to a collection of algorithms to allow a computer to learn as well as adapt based on feedback and conditions at the time of occurrence, resulting in the ability to change the outcome of future responses, based on prior feedback.

“Medium Earth Orbit (MEO),” as used herein, refers broadly to the region of space around the Earth above LEO but below GEO, e.g., between approximately 5,000 km to 12,000 km above the Earth's surface (measured from sea level).

“Low Earth Orbit (LEO),” as used herein, refers broadly to an Earth-centered orbit with an altitude of approximately 500 km, above the Earth surface (measured from sea level). LEO may also be below approximately 1,600 km, for example about 1,000 km, or as low as 160 km.

“Network Management System (NMS),” as used herein, refers broadly to a system designed for monitoring, maintaining, and optimizing a network. The NMS may comprise a combination of hardware and software. The NMS may also be virtual, e.g., software based.

“OpenAMIP,” as used herein, refers broadly to an interface standard based on IP networked interface defined between an Antenna Control Unit (ACU) and the satellite modem.

“Physical medium access,” as used herein, refers broadly to the N-dimensional attributes required to channelize a physical medium.

“Sensor data,” as used herein, refers broadly to data accessed from local sensors in the proximity of the communications terminal system including but not limited to thermometers, barometers, light sensors, and combinations thereof. The communications terminal system may be electronically coupled to a sensor or a plurality of sensors.

“Static data,” as used herein refers broadly to data this unchanging or so rarely changed that it can, optionally, be stored remotely. In an embodiment, static data is updated periodically or sporadically. Static data may be referred to as historic data.

“User input data,” as used here, refers broadly to data provided to the system by a user, e.g., operator.

### Intelligent Roaming Systems and Methods

This disclosure provides for a communication network comprising a ground station comprising a modem communicatively coupled to at least one aerial or space communications platform communicatively coupled to at least one communications terminal system comprises a HPC-based satellite modem configured with machine learning capability, a terminal with access to a plurality of repeating relays, a terminal with access to regenerative relays with on-board processing, a terminal with a directional antenna requiring pointing to at least one aerial or space communications platform for connectivity, a terminal with a plurality of input parameters to enable decisions to be made based on an initial starting location.

### Machine Learning Processing

Current SATCOM systems have several disadvantages over the systems and methods described herein. Current SATCOM systems are built from purpose-built hardware, software, and firmware, and do not have the level of reconfigurability of the systems and methods described herein. These purpose-built systems were not designed to support machine learning nor are they capable of being upgraded to support these new forms of processing. With the new HPC architecture, machine learning becomes a tool that may be utilized as part of the processing capability of the new virtualized modem architecture. Even the Software Define Radio (SDR) solutions, which are based on semi, purpose-built hardware, are limited to the use of machine learning configured architectures.

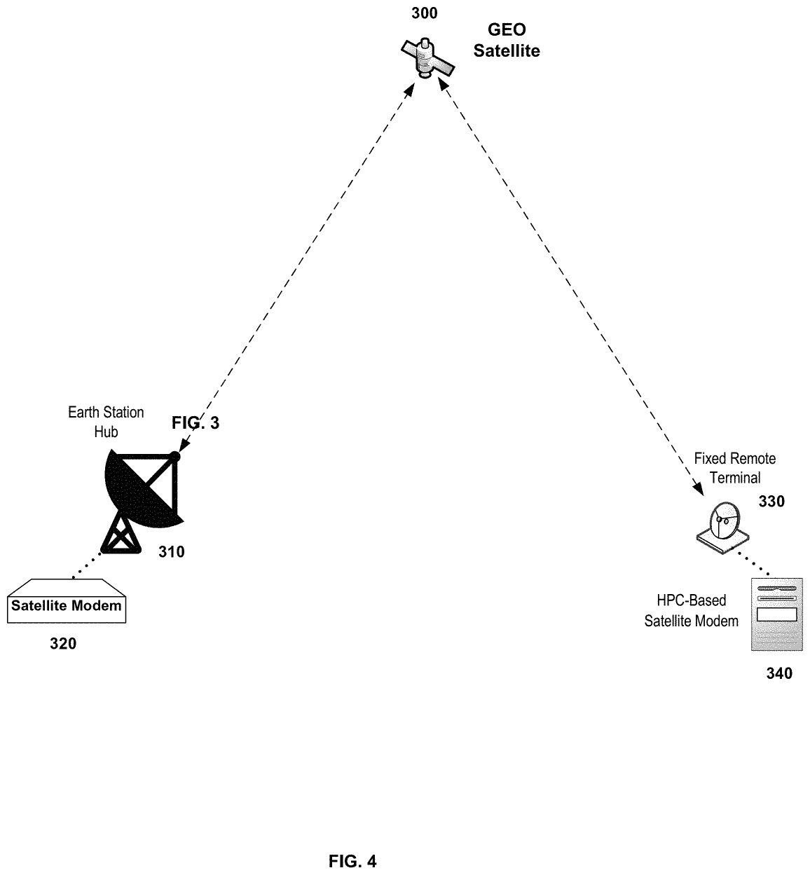

An advantage over current systems is that the systems and methods described herein allow the machine learning to be utilized where the current systems are limited to one function (e.g., a modem) and adapting to changes using linear logic to overcome both roaming and adjusting for changing events to attempt to provide a reliable communications medium given these limited tools. A diagram overviewing the virtual environment of the systems and methods described herein is depicted in FIG. 4. The ability to provide a CPU combined with the hardware acceleration device, see also U.S. Pat. No. 10,397,038, allows the machine learning processing to be natively supported.

Additionally, the systems and methods described herein comprise virtual appliances, which virtualize key network functions and use hardware accelerator and assigns resources as necessary to the virtual functions, as needed. Virtual appliances are flexible hardware containers that support heterogeneous computing and flexible functions for signal processing and medium access.

The systems and methods described and shown herein provide hardware and virtualized architecture to support a roaming terminal comprised of a plurality of mediums. The systems described herein comprise a terminal that utilizes current information to provide a solution with agility that solves current connectivity, accessibility, and cost problems in the SATCOM field. The systems and methods described herein can be used to deploy a plurality of communications protocols or waveforms across a plurality of mediums. Additionally, the systems described herein support reconfigurable systems that send or receive signals on a medium for applications stationary communications with a steerable antenna, communications on the pause (COTP), and communications on the move (COTM). For example, the system architecture described herein can become a communications system for a system that is static but can move the antenna to select an optimal communications path. The system architecture described herein can be a communication on the pause where the terminal is moved and then can be deployed. The system architecture described herein can be a communication on the move where the terminal is starting and/or stopping, or in motion for long or constant periods of time. The introduction of LEO and/or MEO satellites may be considered, in addition to the terminal moving, the repeating relay, regenerative relays with on-board processing, or a combination thereof, may be moving. In a non-limiting case, the satellite may be replaced with an airborne relay as well as a network of balloons. SATCOM using space-based relays are described herein. The methods and systems described herein may also be used in communications systems supported by airborne relay, tethered/balloon relay, terrestrial relay/repeater, and combinations thereof. This flexibility and adaptability of the systems described herein combined with the reduced costs solves problems with the current inflexibility and lack of adaptability in current hardware-based SATCOM systems.

The methods and systems described herein provide a technical solution to a technical problem and they are directed to collection, comparison and classification of information by Machine Learning means to solve the problem of disruption of communications networks by adverse conditions and/or events. For example, the integration of the HPC-based satellite modem configured with machine learning capability for dynamic evaluation and selection of satellites into a SATCOM, or other communications network, changes the normal operation of a communication system to solve the problems arising in the computer network of addressing adverse conditions and/or events.

The systems described herein may be a self-optimizing network (SON) configured to automatically optimize network quality based on heterogeneous data, optionally both dynamic and static data, from disparate sources of data, e.g., public, private, and government-maintained databases, sensors. The machine learning may use advanced algorithms to access heterogeneous data, optionally both dynamic and static data, from disparate sources of data, analyze for patterns within the data, detecting and predict network anomalies, possible inefficiencies, disruptions to service, and proactively recommend changes in the network configuration before service is negatively impacted, optionally enacting the changes in the network configuration.

### Machine Learning Enabled Communications Systems

Current SATCOM systems utilize static decision matrices for choosing a given satellite service based on the geographic location on or over the earth, defined by latitude and longitude points for the selection of the satellite service. Using intelligent roaming, the latitude and longitude are used, but the implementation of machine learning allows for the trajectory of the vehicle, altitude, terrain, weather conditions, as well as available services, and optimal waveforms to be factored into the selection of the service to meet a given communications demand. In effect, the system and methods described herein enable a dynamic decision matrix to be used for choosing a given satellite service.

Computing resources are generally based on Central Processing Units (CPUs) becoming heterogeneous (e.g., relying on other silicon architectures for computing) by leveraging Field Programmable Gate Arrays (FPGAs), Application Specific Integrated Circuits (ASICs), Graphics purpose Processing Units (GPUs), Digital Signal Processors (DSP), and combinations thereof, for hardware acceleration.

In High Performance Computers (HPC), CPU architecture with hardware acceleration is used as part of computing architectures, enabling real time signal processing. In practice, access to accelerators was established through purpose-built hardware designed around the accelerator or integrating acceleration into existing designs. Integration is now easier, where accelerators can be deployed as separate modules into computing architectures, e.g., through PCIe (peripheral component interconnect express) cards in network servers. CPU architectures may provide interfaces to allow for direct programing and easier access to hardware acceleration. The HPC architectures may preferably be configured with machine learning architectures since the hardware accelerator allows for higher levels of performance than would be achieved with CPU-only processing.

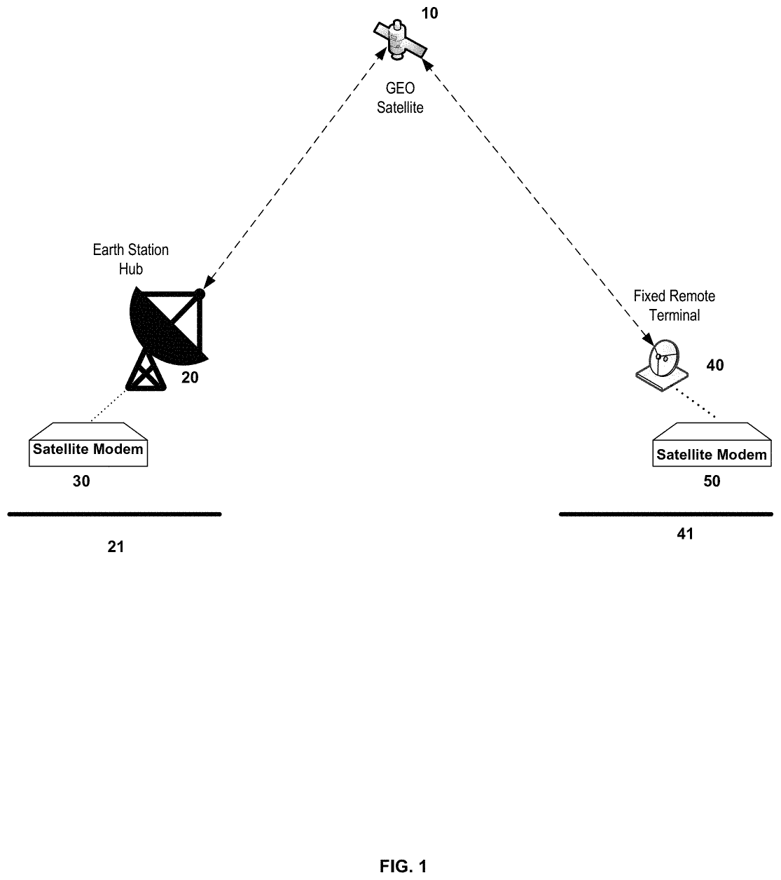

In reference to FIG. 1, which depicts an embodiment of a “fixed” satellite terminal 40 operating with purpose-built hardware operating over through a GEO satellite 10. A purpose-built architecture, data and management interfaces are shown at 21; Physical Layer (PL) transmit (TX) and receive (RX) interfaces to the physical access medium are shown at 41. The physical access medium may be any suitable medium that can support transmission of a signal, which can be a radio frequency, free space optical, Ethernet, fiber optic, sonar, and combinations thereof. In the modem architecture 30 (transmitting) and 50 (receiving) shown in FIG. 1, a hardware accelerator may perform signal processing. In many applications this maybe a field-programmable gate array (FPGA) or application-specific integrated circuit (ASIC). The FPGA/ASIC performs primarily signal and packet processing. Signal processing includes the translating of data bits into baseband symbols/samples, which are converted to analog signals and then sent out via a physical interface. In addition to baseband symbols, the signal processing part of modems translates the digital signal to analog signals and assigns the frequency for the physical medium. The conversion of the digital signal signals to/from analog signals involves the use of a Digital to Analog Converters (DACs) and Analog to Digital Converters (ADCs). Those analog signals are then transmitted into the physical medium through additional PL hardware specific to the medium. Modem architectures are purpose built, limiting their uses and increasing costs. The fixed nature of the terminal means that one terminal is directed to one satellite for the entire operational life of the terminal. In the event the satellite becomes inoperable, all services will cease to the terminal until a change is made to the terminal to manually repoint the terminal to a new satellite or a new satellite is flown in to replace the failed satellite. The system 40 is unable to proactively reconfigure the communications network or access/process data to make recommendations on avoiding a disruption in the communication network.

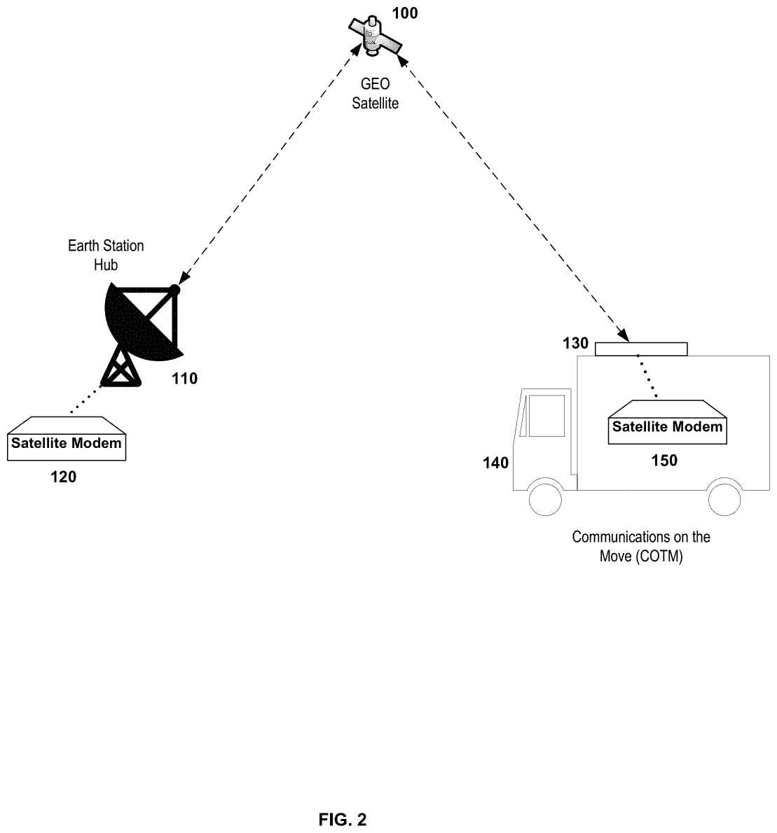

FIG. 2 depicts an embodiment comprising a communications on the move (“COTM”) satellite terminal 140 operating with purpose-built hardware operating through a single GEO satellite 100. The mobile nature of the terminal means that one terminal is directed to one satellite during the normal operation of the terminal. In the event that the satellite can no longer be observed, the COTM terminal will cease operation and will not “repoint” and all services will be rendered inoperable. The system 140 is unable to proactively reconfigure the communications network or access/process data to make recommendations on avoiding a disruption in the communication network.

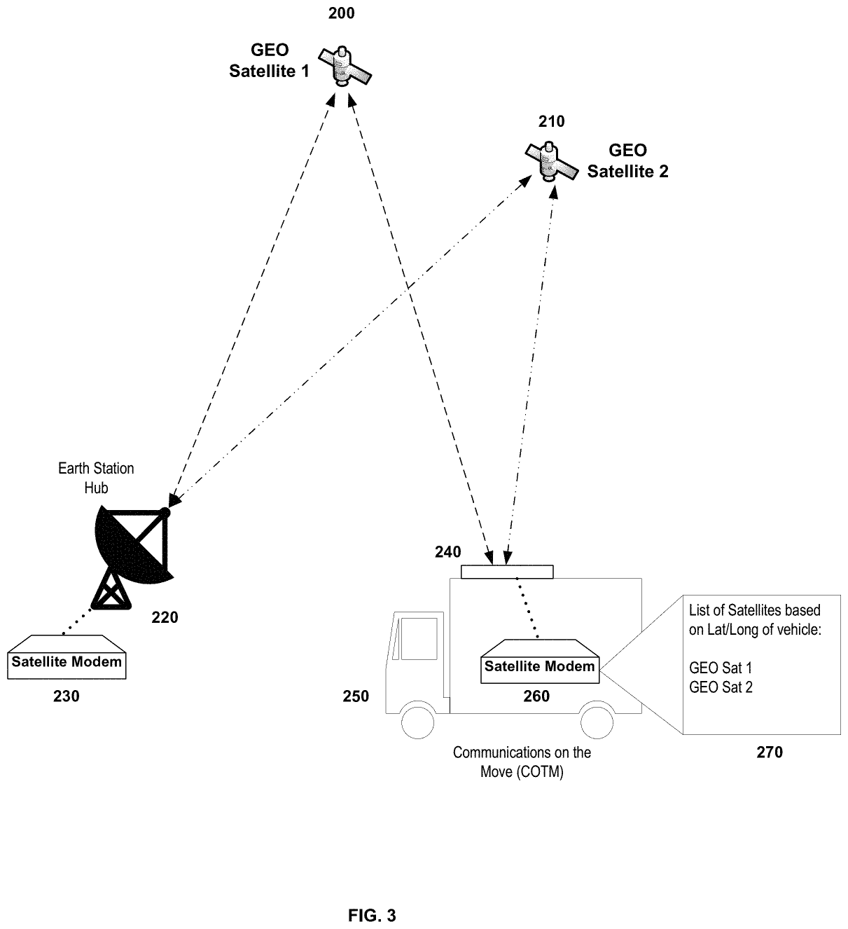

FIG. 3 depicts an embodiment of a communications on the move (“COTM”) satellite terminal 250 operating with purpose-built hardware operating through a GEO satellite 1 200 and GEO satellite 2 210. The mobile nature of the terminal shows that one terminal is directed to one or more satellites during the normal operation of the terminal. In the event that GEO satellite 1 200 can no longer be observed, the COTM terminal 250 will “repoint” to a new satellite 210 and service will be extended. In this embodiment, the ability to “roam” is based on static rules based on the latitude and longitude on or over the Earth. The choice of satellite is executed in a limited manner without the input of extraneous data, where the footprint of the satellite is known and when the signal strength becomes too low back on the satellite's beam density, the terminal moves to a new satellite. The system 250 relies on static data, generally sporadically updated, and cannot access and/or process any dynamic data, generally updated in real-time, to make proactive recommendations and reconfigurations of the communications network to avoid disruptions and otherwise optimize the communications network.

FIG. 4 depicts an exemplary Virtualized Modem (VM) architecture 340, where the modem architecture 50 shown in FIG. 1 is replaced by a VM architecture 340 with a CPU and a hardware accelerator as a heterogeneous processing architecture supported by a high-level coding language. Suitable systems are described, for example, in U.S. Pat. Nos. 10,177,952; 10,397,038; and 10,505,777. The HPC-based satellite modem configured with machine learning capability 340 enables a dynamic manner for the terminal 330 to move beams from the GEO Satellite 300 to other possible aerial communications platforms, relying on a heterogeneous mix of information sources and types of data to make the recommendations, and, in an embodiment, the changes after the analysis. For example, the HPC-based satellite modem configured with machine learning capability 340 has the ability to access a variety of data sources and process heterogeneous data to make recommendations for the optimization of the communications network, e.g., avoid disruptions, improve signal strength, and maintain continuity of service.

The communications terminal system may comprise a high-performance computer (HPC)-based satellite modem configured with machine learning capability, access to a plurality of repeating relays, regenerative relays with on-board processing, or a combination thereof, and a directional antenna requiring pointing to at least one aerial or space communications platform for connectivity. The communications terminal system may be configured as to allow it to access and process the data, make a recommendation on configuration of the communication network, and further execute the recommendation to reconfigure the communications network to optimize communications, avoid disruptions, and/or ensure continuity of the flow of information through the communications network. The recommendation is based on machine learning analysis of heterogeneous data accessed from static database, dynamic databases, local sensors, user input data, and combinations thereof.

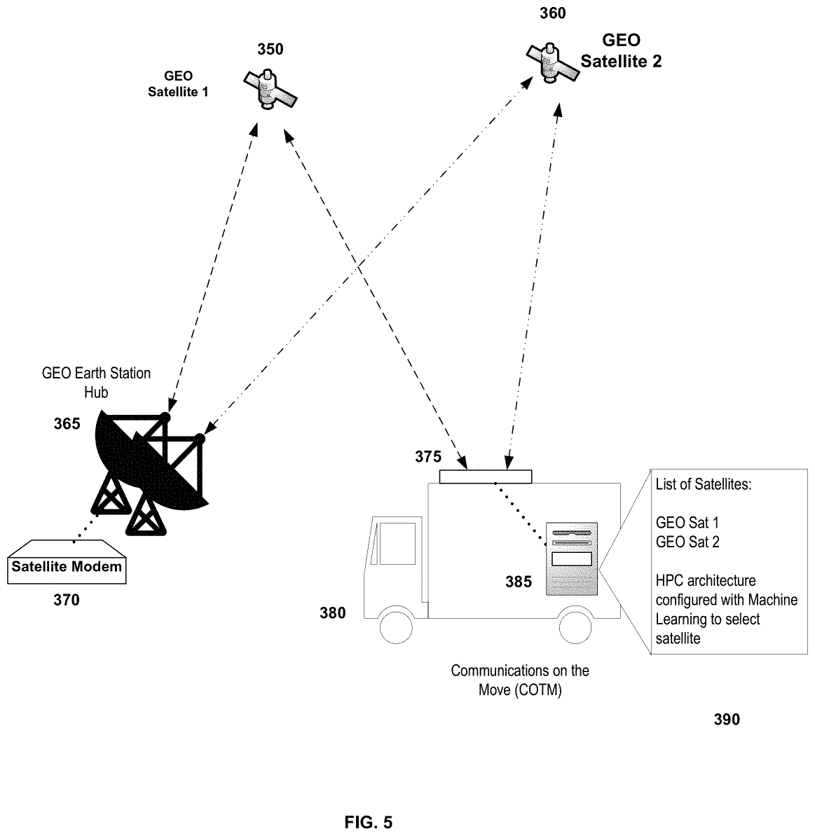

FIG. 5 depicts an exemplary Virtualized Modem (VM) architecture 385, where the modem architecture 50 shown in FIG. 1 is replaced by a VM architecture 385 with a CPU and a hardware accelerator as a heterogeneous processing architecture supported by a high-level coding language and machine learning capability. Suitable systems are described, for example, in U.S. Pat. Nos. 10,177,952; 10,397,038; and 10,505,777. The CPU and a hardware accelerator as a heterogeneous processing architecture are supported by a high-level coding language and machine learning capability is integrated into the communications network to form a self-organizing network (SON) that can self-optimize, self-configure, and self-heal, e.g., repair problems and errors. For example, the communications terminal system 380 (depicted as a COTM) may proactively monitor conditions, including but not limited to signal strength, demand for satellite service, weather data, terrain data, video data, geographic data, traffic data, satellite cost data, crowd-sourced data, signal strength, satellite positions, cost of satellite service, transmission times, obstructions to communications, wavelengths, and combinations thereof, to identify potential disruptions in the communications network, and make recommendations to optimize the communications network, and/or execute the recommendations to optimize the communications network. The communications terminal system 380 (depicted as a COTM) may be configured to receive data from local sensors and process that data. Further sources of data include historical data stored locally, user input data, consumer demand information, government promulgated information and directives, and combinations thereof.

The machine learning capability to access and process heterogeneous data in making recommendations and/or executing them further expands the capabilities to bring to bear roaming and beam switching capabilities to include dynamic modeling. Dynamic modeling is described, for example, in U.S. Pat. No. 8,914,536. The Es/No (energy of a given signal over the noise density) or Eb/No (energy of a bit over the noise density) of an operational terminal may be sampled to obtain how the receive signal of a reference carrier may be used to gauge how well the signal path is performing as the terminal is operating. The Es/No is approximately equal to the C/N (carrier over the passband noise) and is a reference to the S/N (signal to the passband noise) of a received carrier. As signal level degrades, proactive measures may be taken to notify the sender to use a more robust waveform using a technique known as Adaptive Modulation and Coding (ACM) or the signal level may degrade to the point where a new beam must be considered. There are many factors to be considered when deciding to remain on a given beam or roam/switch to a new beam. The decision to move from one beam to another may be based on three factors:
(1) There is a geographic need to move to a new beam, since the terminal has reached the beam edge;
(2) There is a blockage preventing the antenna from utilizing the beam and if there is another satellite or antenna that may be chosen, then a switch to another satellite or beam may be needed; and/or
(3) There is a fading situation where the beam has become degraded and, in this case, if a backup beam is available in a backup list, then an attempt may be made to use the backup beam.

In current systems and methods, the decision to change beams or antennas is done using limited information and the decision to make the beam change is accordingly limited. The inventors surprisingly discovered that the integration of an HPC-based satellite modem configured with machine learning capability 390, which relies on a heterogeneous mix of information sources and types of data, enables a dynamic manner for the terminal 385 to move beams from GEO Satellite 1 350 to GEO Satellite 2 360. The positioning of the antenna takes place with a device known as an Antenna Control Unit (ACU). The ACU controls the position (pointing direction) of the antenna. Additionally, there is a connection between the ACU and the modem via a protocol known as Open Antenna to Modem Protocol (OpenAMIP). OpenAMIP is a protocol standard that utilizes the Internet Protocol (IP) allowing an interface between an ACU and a Modem. The OpenAMIP protocol allows for the VM supported by the HPC to utilize the described invention allowing control/position requests commands and responses over the OpenAMIP interface to/from the ACU, thus allowing for repositioning the antenna based on the results of the described invention.

There are measures taken after the HPC-based satellite modem configured with machine learning capability 385 evaluates the receive signal level and can help move the terminal, even prematurely, in the event signal strength is reduced, but this is done with adaptability or learning for future corrections and adjustments based on any ability to learn how to make it better or the ability to more intelligently make a decision to move to a new configuration as described herein. The machine learning capability processes extraneous data, comprising both dynamic and static data, to optimize the satellite communications network. The machine learning is logic intensive and the HPC architecture can support the machine learning architecture. By using machine learning, instead of relying on a limited set of static data, the machine learning system accepts data from a plurality of sources of disparate information, processes the data via a machine learning system known as “reinforcement learning,” where a given set of bounds are established, and the algorithm is allowed to move through the bounds (limitations) with the goal of finding a successful communications path, while looking at future events with an attempt to ensure the link is first solvable, and then as efficient as possible, reliable, and sustainable. The learned information is retained and stored for future use as well as to provide to other “like systems,” for use in similar situations. The learned information may be stored in a local database and/or in a remote database, e.g., cloud-based database. This same system has a provision to input/receive other learned information from other “like systems,” so that systems that have experienced, e.g. learned, can train a terminal how to deal with similar experiences. For example, separate communications terminal systems likewise configured may share information, including but not limited to learned information for optimizing communication networks. Further, the machine learning system may be trained with data to configure the satellite network to optimize communications, including but not limited to historical data, current data, user input data, data accessed from local sensors, and combinations thereof.

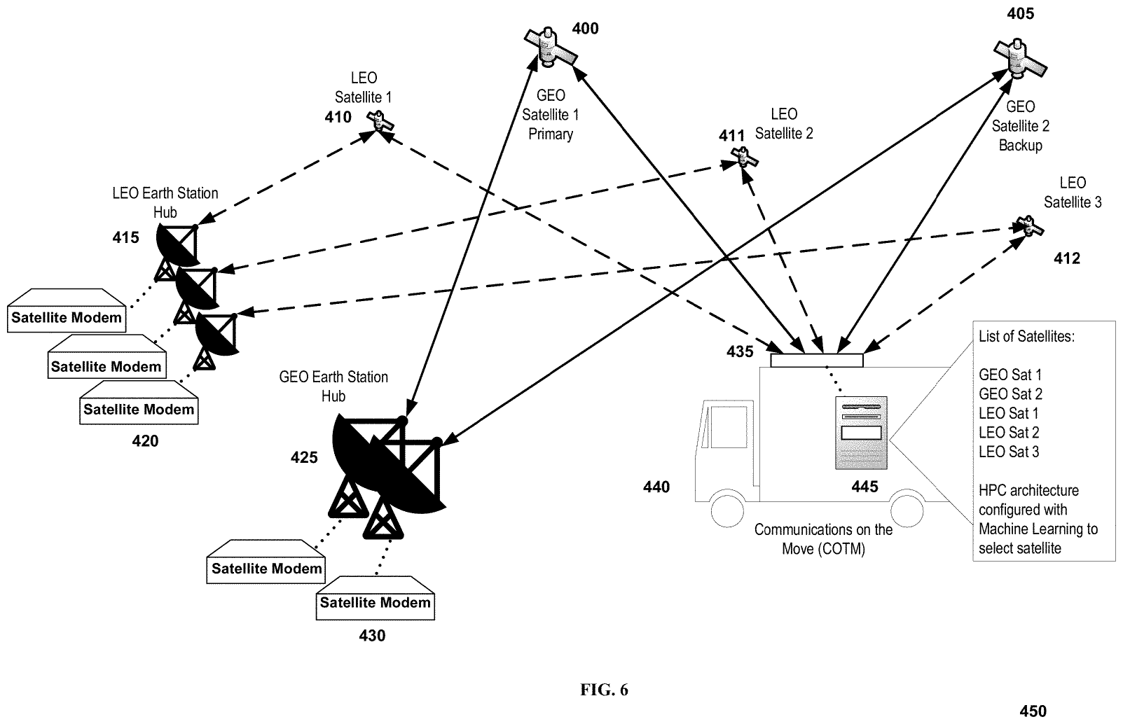

FIG. 6 depicts the use of a method described herein showing a terminal configured on a communications on the move (COTM) platform 440 supported by GEO satellites as the GEO satellite 1 acting as the primary 400 and a backup GEO satellite GEO satellite 2 405. The two types of satellites, GEO and LEO, are supported by separate hubs, GEO Earth Station Hub 425 and LEO Earth Station Hub 415 using satellite modems 420 and 430 located at each hub. When both GEO satellite 1 400 and GEO satellite 2 405 become unavailable, a backup service may be established using LEO satellite 1 410, LEO satellite 2 411, and LEO satellite 3 412. The COTM platform is configured with HPC-based satellite modem 445 utilizing machine learning capability for dynamic evaluation and selection of satellites to maintain the communications system in the event of disruptions of the SATCOM system. For example, if a weather event is about to take place in the path of a COTM platform 440 resulting in a partial, or even complete outage on the primary and secondary path to the GEO satellites 400 and 405, the machine learning capability 450 operating on the HPC-based satellite modem 445 may be used to move the SATCOM links to a new satellite(s). The COTM platform is configured with HPC-based satellite modem 445 utilizing machine learning capability for dynamic evaluation and selection of satellites to maintain communications system in the event of user requests. For example, service could move from the GEO satellite 1 400 and GEO satellite 2 405 to the LEO satellites, LEO satellite 1 410, LEO satellite 2 411, LEO satellite 3 412, and combinations thereof. This change may be made even though the original satellite service may have a lower cost of operation, since it may be better to be proactive and move to a more expensive service, to avoid a partial, or total, communications outage. The inventors discovered that the use of the HPC-based satellite modem 445 utilizing machine learning capability for dynamic evaluation and selection of satellites to maintain communications system is better than the current system which rely on static systems, limited information, and have no flexibility.

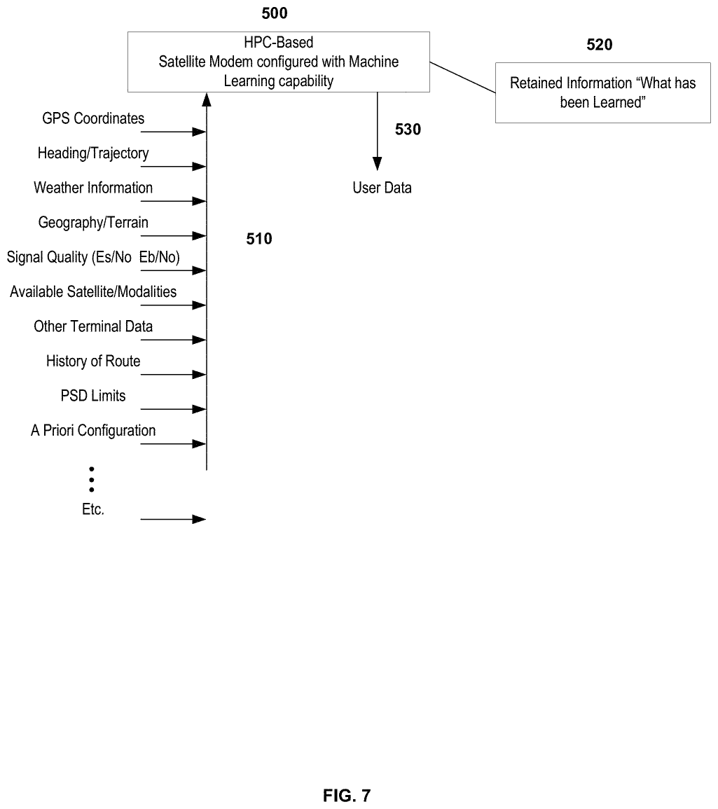

FIG. 7 depicts a flowchart for HPC-based satellite modem configured with machine learning capability 500 and the input stimulus 510 for the processing that enables the introduction of the machine learning processing. A variety of disparate input stimuli 510 may be provided into the machine learning capability to allow the beam roaming to take place as well as what was “learned and retained” as a result of the machine learning process 520. The end result of successfully moving to a new satellite or new satellite service enables the output of user information “data” 530 that may be outputted from the modem. Optionally, the user data may be provided by means of a user interface. Unlike current systems, a plurality of heterogeneous input stimuli 510 may be utilized by the machine learning processing for determining the optimal configuration and recommended mode of operation. The implementation of the machine learning capability with the HPC-based satellite modem allows for more resilient operation, e.g., faster, improved, more efficient use of SATCOM resources in adverse conditions. The learned information may be retained and stored for future use as well as to provide to other “like systems,” for use in similar situations. This same system is configured with a provision to input/receive other learned information from other “like systems,” so that systems that have experienced, e.g. learned, can train a terminal how to deal with similar experiences. For example, the HPC-based satellite modem configured with machine learning capability 500 may access data, including learned information, from other communications terminal systems. Likewise, the HPC-based satellite modem configured with machine learning capability 500 may share data, including learned information, with other communications terminal systems.

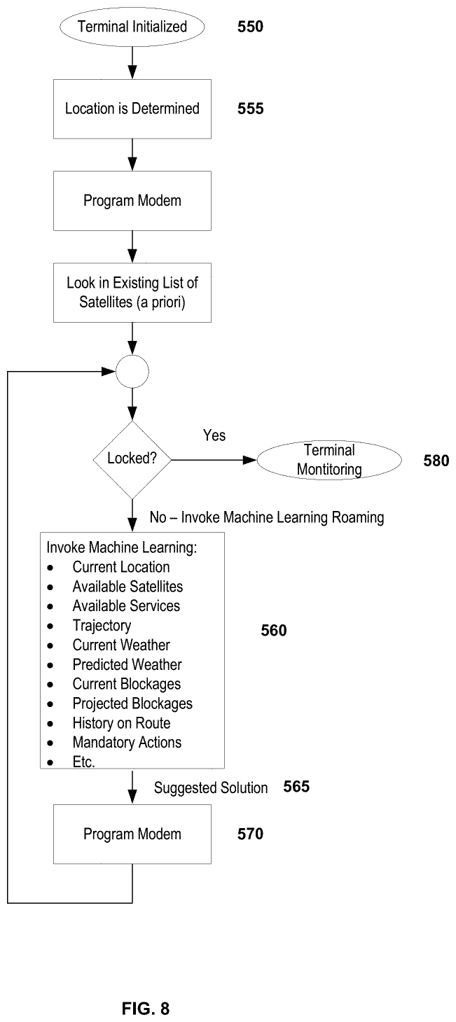

FIG. 8 depicts a flowchart depicts exemplary machine learning processing 560 that may take place that is considerably more complex than a standard logic engine where input data must follow linear processing logic for providing beam roaming. In current systems, only “bound or known expected results” (limited data) are output as a result for roaming from one beam, satellite, or service. This limits the responsiveness and possible reconfigurations of the SATCOM system. In the system and methods described herein, overall function that supports the initialization of the beam roaming starts at initialization 550. The first step before any terminal is to know where the terminal is currently located. For a fixed terminal, step 555 may be omitted. Upon implementation of the machine learning processing 560, a multitude of dissimilar input data (examples are listed in 560) may be inputted and many scenarios may be considered before the final recommendation denoted as the suggested solution 565 has been reached. The machine learning process generates several possible suggestions and potential outcomes to be related to the user, which can be implemented to ensure the terminal does not leave the network or the impact of an event does not result in degradation to the terminal that may otherwise completely avoided. The machine learning system may identify solutions including, but not limited to, being available, assumed cost, assumed latency, provide an assumed duration, and combinations thereof. The machine learning system is logic intensive and the HPC architecture natively lends itself to supporting these architectures. The machine learning system accepts data from disparate sources of information, processes the data via reinforcement learning, where a given set of bounds are established, and the algorithm is allowed to move through the bounds (limitations) with the goal of finding a successful communications path, while looking at future events with an attempt to ensure the link is firstly solvable, efficient as possible, reliable, and sustainable. A preferred machine learning system is a reinforced learning system using an algorithm selected from the group consisting of linear regression, logistic regression, decision tree, support vector machine (SVM), Naïve Bayes, k-nearest neighbors (kNN), K-means, Random Forest, Dimensionality Reduction Algorithms, Gradient Boosting algorithms, a Monte Carlo algorithm, Q-learning algorithm, State-action-reward-state-action (SARSA) algorithm, Q-learning—lambda algorithm, SARSA-lambda algorithm, DQN (Deep Q Network) algorithm, DDPG (Deep Deterministic Policy Gradient) algorithm, A3C (Asynchronous Advantage Actor-Critic Algorithm) algorithm, NAF (Q-learning with normalized Advantage functions) algorithm, TRPO (Trust Region Policy Optimization) algorithm, PPO (Proximal Policy Optimization) algorithm, TD3 (twin delayed deep deterministic policy gradient) algorithm, SAC (Soft Actor-Critic) algorithm, or an ensemble thereof. The Gradient Boosting algorithm may be gradient boosting machine (GBM), extreme gradient boost (XGBoost), LightGBM, CatBoost, or an ensemble thereof.

Input Stimulus with Machine Learning Processing for Roaming Applications

FIG. 7 depicts the input that may be input into the Machine Learning processing to “consider” for making roaming recommendations in accordance with the systems and methods described herein. Here, a variety of heterogeneous data is accessed by the HPC-based satellite modem configured with machine learning capability including but not limited to GPS coordinates, heading/trajectory of a satellite or plurality of satellites, weather information, geography/terrain, signal quality (Es/Nb, Eb/No), available satellites/modalities, other terminal data, history of route, PSD limited, a priori configuration, or a combination thereof. In the event conditions change at the receiver (the downlink side) status messages are sent back to the sender as to how well the signal is being received (in real-time, in view of changing conditions/events). In the systems and methods described herein, if the signal level is degrading the received Es/No or Eb/No (by the receiver) 510 is sent back to the sender (again, in real-time in view of changing conditions/events). All movement of the beams that are being utilized by the remote terminal are handled at the terminal's end. The hub adjusts the modulation and coding (MODCOD), using Abstract Control Model (ACM,) based on the reported Es/No or Eb/No reports 510 from the remote terminal. Periodic reports are sent back, on a regular, predetermined schedule, but in addition, the remote terminal is more capable of processing how the information is being sent from the sender to the remote terminal. Further, reports may be sent on a demand basis and/or in response to changing conditions/events. For example the remote terminal may use additional, optionally unrelated, disparate information including but not limited to weather radar, trajectory, current or expected blockages, to plan, using Machine Learning, optionally reinforced learning, 510 and notify the hub that it plans to make changes to how it will be operating. Additionally, the remote terminal may not notify the hub of the planned changes and make the changes in an autonomous fashion based the results of the machine learning processing. The machine learning processing may be performed is based on, but not limited to, the following input: weather radar, weather information, historic and/or current information plus predicted weather information, cloud density, including changes to cloud density, precipitation rates, altitude, velocity, planned route(s), blockages by the vehicle, blockages based on terrain, blockages due to buildings, denial of services due to regulatory constraints, denial of services to power, power spectral density (PSD) limitations, government-mandated blackouts, GPS coordinates, signal quality, available satellites/modalities, history of route, heading/trajectory of a communications means, e.g., satellite, planned and/or unplanned maintenance of communications means, e.g., satellites, current location of communications means and network components, available services, and combinations thereof. The system 500 may store learned information in a database 520, maintained locally and/or remotely.

Processing such heterogeneous and dynamic data by the system 500 may result in the machine learning process generating a decision to make a change or a list of recommended changes, and may include ranking of the changes, based on level of degradation of services, cost of services, duration of the available service, and combinations thereof. The ability to provide adaptively and learning via the machine learning provides an unexpected improvement in the resilience and reliability of the communications network, e.g., SATCOM network. The ability to apply machine learning allows the algorithm to consider a much larger number of inputs and consider the results from a problem solving, learning, or most importantly planning perspective. The Machine Learning used in the systems and methods described herein may comprise:
(1) Supervised learning—which is task learning and predicts behavior using past experience.
(2) Unsupervised learning—which is data driven and uses algorithm discoveries based on similarities and hidden configurations within data.
(3) Reinforcement learning—which is environment-driven where algorithms learn to react to an environment and have intelligent behaviors.

Reinforcement learning is a preferred approach where the algorithm learns to react based on the environment, e.g., input stimulus based on the available input with the result being a decision on what must be done, options that are ranked as to the best decisions of what must be undertaken, and possibly suggestions to a remote hub as to what decisions are to be undertaken.

The machine learning system in the system and methods described herein may use an algorithm selected from the group consisting of linear regression, logistic regression, decision tree, support vector machine (SVM), Naïve Bayes, k-nearest neighbors (kNN), K-means, Random Forest, Dimensionality Reduction Algorithms, Gradient Boosting algorithms, or an ensemble thereof. The Gradient Boosting algorithm may be gradient boosting machine (GBM), extreme gradient boost (XGBoost), LightGBM, CatBoost, or an ensemble thereof.

### Reinforced Learning

Reinforcement learning (RL) is a form of machine learning concerned with how intelligent agents ought to take actions in an environment in order to maximize the notion of cumulative reward. Reinforcement learning differs from supervised learning in not needing labelled input/output pairs be presented, and in not needing sub-optimal actions to be explicitly corrected. Instead, the focus is on finding a balance between exploration (of uncharted territory) and exploitation (of current knowledge). “Reinforcement Learning algorithms—an intuitive overview.” By Robert Moni SmartLab AI website (2021).

The environment may be stated in the form of a Markov decision process (MDP) because many reinforcement learning algorithms for this context use dynamic programming techniques. One difference between the classical dynamic programming methods and reinforcement learning algorithms is that the latter do not assume knowledge of an exact mathematical model of the MDP and they target large MDPs where exact methods become infeasible.

The reinforcement learning may utilize a Monte Carlo algorithm, Q-learning algorithm, State-action-reward-state-action (SARSA) algorithm, Q-learning—lambda algorithm, SARSA-lambda algorithm, DQN (Deep Q Network) algorithm, DDPG (Deep Deterministic Policy Gradient) algorithm, A3C (Asynchronous Advantage Actor-Critic Algorithm) algorithm, NAF (Q-learning with normalized Advantage functions) algorithm, TRPO (Trust Region Policy Optimization) algorithm, PPO (Proximal Policy Optimization) algorithm, TD3 (twin delayed deep deterministic policy gradient) algorithm, SAC (Soft Actor-Critic) algorithm, or an ensemble thereof. “Reinforcement learning in artificial and biological systems.” Neftci & Averbeck (2019) Nature Machine Intelligence 1: 133-143.

The reinforcement learning system may be trained using historical data, and, optionally, trains in real-time by accessing and processing static and dynamic databases. An advantage of reinforcement learning is that the machine learning system may constantly train using real-time data to improve recommendations based on gathered data, including using both historical and current data.

The methods and systems described herein solve an existing problem in the SATCOM field, indeed in the telecommunications field, of being able to proactively and dynamically monitor, maintain, and change communications networks in response to rapidly changing and/or disparate events, conditions, and data. The current SATCOM systems rely on purpose-built hardware with fixed, static data to move from fixed, static network configurations. In contrast, the methods and systems described herein allow for the HPC-based satellite modem utilizing machine learning capability for dynamic evaluation and selection of satellites to maintain communications system in the event of disruptions of the communications system. The methods and systems described herein are more resilient, more efficient, and can provide better operations under adverse conditions/events.

For example, a method for sending a message via a communications network may comprise receiving a message at a ground station comprising a modem communicatively coupled to at least one communications platform communicatively coupled to at least one communications terminal system comprising a high-performance computer (HPC)-based satellite modem configured with machine learning capability, access to a plurality of repeating relays, optionally access to regenerative relays with on-board processing, and a directional antenna requiring pointing to at least one aerial or space communications platform for connectivity, determining a communications network for the message comprising accessing data, the communications terminal system comprising a high-performance computer (HPC)-based satellite modem configured with machine learning capability, processing the data using a machine learning system, and generating a recommendation for configuration of a communications network, sending the message across the recommended communications network configuration.

The communications terminal system may be a fixed terminal, Communications on the Move (COTM) system, Communication on the Pause (COTP), or a combination thereof. The communications on the move (COTM) may comprise a vehicle, a HPC-based satellite modem configured with machine learning capability, an antenna, and is mobile. The communication on the pause (COTP) system may comprise a vehicle, a HPC-based satellite modem configured with machine learning capability, an antenna, and is mobile. The vehicle may be a surface vehicle or an airborne vehicle. The communications terminal system may be further coupled to a terminal with a plurality of input parameters to enable decisions to be made based on an initial starting location.

The ground station may comprise a ground station for receiving communications from a repeating relay from a plurality of repeating relays, regenerative relays with on-board processing, or a combination thereof.

The communications platform may be an aerial communications platform, space communications platform, or a combination thereof. The space communications platform may be a LEO satellite gateway, GEO satellite gateway, or MEO satellite gateway acting as a communications end point or a communications relay. The aerial communications platform may comprise a satellite, airplane, balloon, drones, helicopters, airships (zeppelins), rockets, and combinations thereof, acting as a communications end point or a communications relay.

The communications terminal system may be processes a plurality of input parameters to enable decisions to be made based on an initial starting location of the communications platform. The method may further comprise generating a further network configuration recommendation and reconfiguring the communications network based on the further recommendation. The communication terminal may be a fixed terminal.

The machine learning capability may comprise a machine learning system. The machine learning system may be trained using historic data. The machine learning system may comprise a high-performance computer existing as a central processing unit and combined with a hardware acceleration device, while operating in a heterogeneous fashion. The machine learning system may access and/or process data from static databases, dynamic databases, and combinations thereof. The machine learning system access and/or process data comprising weather data, terrain data, video data, geographic data, traffic data, satellite cost data, crowd-sourced data, signal strength, satellite positions, cost of satellite service, transmission times, obstructions to communications, wavelengths, and combinations thereof. The machine learning system access and/or process data dynamic data, optionally updated in real-time, and static data, optionally sporadically updated. The machine learning system access and/or process data stored on public databases, private databases, databases managed by government agencies, and combinations thereof.

The machine learning system may use an algorithm selected from the group consisting of linear regression, logistic regression, decision tree, support vector machine (SVM), Naïve Bayes, k-nearest neighbors (kNN), K-means, Random Forest, Dimensionality Reduction Algorithms, Gradient Boosting algorithms, or an ensemble thereof. The Gradient Boosting algorithm may be gradient boosting machine (GBM), extreme gradient boost (XGBoost), LightGBM, CatBoost, or an ensemble thereof. The machine learning system may be a reinforcement learning system. The machine learning system may utilize an algorithm selected from the group consisting of a Monte Carlo algorithm, Q-learning algorithm, State-action-reward-state-action (SARSA) algorithm, Q-learning—lambda algorithm, SARSA-lambda algorithm, DQN (Deep Q Network) algorithm, DDPG (Deep Deterministic Policy Gradient) algorithm, A3C (Asynchronous Advantage Actor-Critic Algorithm) algorithm, NAF (Q-learning with normalized Advantage functions) algorithm, TRPO (Trust Region Policy Optimization) algorithm, PPO (Proximal Policy Optimization) algorithm, TD3 (twin delayed deep deterministic policy gradient) algorithm, SAC (Soft Actor-Critic) algorithm, or an ensemble thereof. The machine learning system, optionally a reinforcement learning system, may be trained on data from static databases, dynamic databases, and combinations thereof. The machine learning system, optionally a reinforcement learning system, may be trained on data comprising weather data, terrain data, video data, geographic data, traffic data, satellite cost data, crowd sourced data, signal strength, satellite positions, cost of satellite service, transmission times, obstructions to communications, wavelengths, and combinations thereof. The machine learning system, optionally a reinforcement learning system, may be trained on data comprising dynamic data, optionally updated in real-time, and static data, optionally sporadically updated. The machine learning system, optionally a reinforcement learning system, may be trained on data stored on public databases, private databases, databases managed by government agencies, and combinations thereof.

The methods described herein may be performed on the systems described herein.

### EXAMPLES

### Example 1

### Mobile Terminal Moves Through Weather

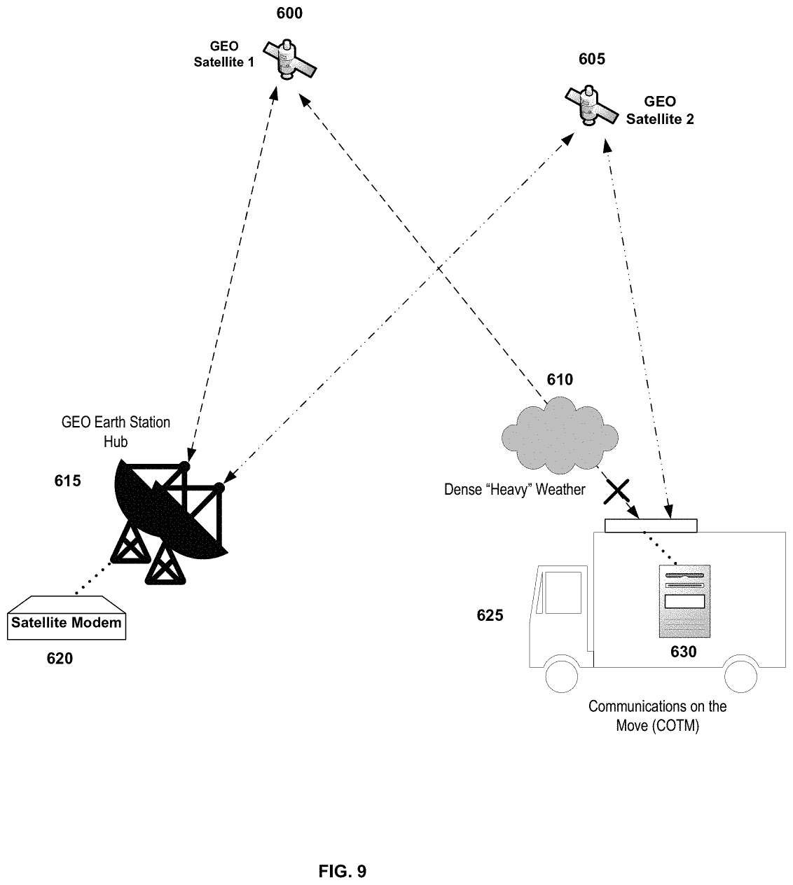

The system and methods described herein have the adaptability of processing weather events, including historical, current, and predicted, into the beam switching processing module. FIG. 9 demonstrates that even though the primary GEO satellite 1 path 600 has a higher power transmission path, the weather event 610 will impact the transmission to the terminal while passing from the satellite to the terminal based on the trajectory of the communications on the move (COTM) 625. FIG. 9 depicts an example of an HPC-based satellite modem configured with machine learning capability 630 moves to a backup satellite service even though the during that transition the communications on the move (COTM) 625 can remain on that backup satellite, GEO satellite 2, 605 will be shorter, since the COTM may be moving away from the backup satellite 605, but in the end providing an overall more reliable service during the path of travel. This is contrary to linear decision making which would favor the GEO satellite 1 600 because the satellite 600 provides higher power, thus provide a higher Es/No or Eb/No, resulting in a more reliable link. The decision to move to the lower power satellite would be contrary to a fixed configuration based on limited data, but the described method and system herein, allows the machine learning system to take into process data concerning a weather event that is going to impact the service, processed by the machine learning, and the machine learning makes a recommendation for proactive measures to be taken prior to having to experience a degradation resulting in the terminal having to experience the degradation. This is in contrast to systems that rely on static information, or post-event information, such as experiencing the degradation and taking corrective action after experiencing the event. This change from GEO Satellite 1 600 to GEO Satellite 2 605 may be made even though the original satellite may have a stronger signal, since it may be better to be proactive and move to a lower powered signal, but not suffer from a total communications outage.

When the weather event 610 is no longer an impact to the service, the HPC-based satellite modem configured with machine learning capability 630 may direct the service back to the primary path to GEO satellite 1 600. The machine learning capability that resides in the HPC-based satellite modem 630 receives information on this condition, e.g., by processing real-time, dynamic weather data, and sends a request to the sender to be moved to a new satellite. Through the use of the HPC-based satellite modem configured with machine learning capability 630, a consideration to move beams may be based on more than the weather conditions, satellite proximity, but may include, but is not limited to, the trajectory of the COTM 625, current weather data in the path of the COTM 625, predicted and/or historical weather data in the path of the COTM 625, terrain in the path of the COTM 625, up-to-date, real time information about traffic, terrain, accidents, and/or construction in the path of the COTM 625, and additional available services or bands. This data may be collected and processed by the actions that may be the HPC-based satellite modem configured with machine learning capability 630 from disparate sources, including historical data, government data, weather data, and geographic data, stored on private and/or public databases. The HPC-based satellite modem configured with machine learning capability 630 may also rely on learning from actions taken by the system in previous circumstances. The HPC-based satellite modem configured with machine learning capability 630 may perform additional processing including, but not limited to sending a request to the sender (inbound carrier) that a new beam, satellite, waveform, service, is recommended. Accordingly, the systems and methods described herein provide greater flexibility and resilience to a communication network, e.g., SATCOM network, by the utilizing a HPC-based satellite modem configured with machine learning capability 630 that receives, processes, and produces recommendations on network management based on dynamic, real-time, data on weather, terrain, geography, satellite positions, cost of satellite service, transmission times, obstructions to communications, wavelengths, signal strengths, and combinations thereof, gathered from disparate static and dynamic databases. The machine learning system accepts data from a plurality of input sources of information, process the data via the machine learning infrastructure using a structure known as “reinforcement learning” where a given set of bounds are established, and the algorithm is allowed to move through the bounds (limitations) with the goal of finding a successful communications path, while looking at future events with an attempt to ensure the link is firstly solvable, efficient as possible, reliable, and sustainable.

### Example 2

### Mobile Terminal Moves Through Hard Blockages

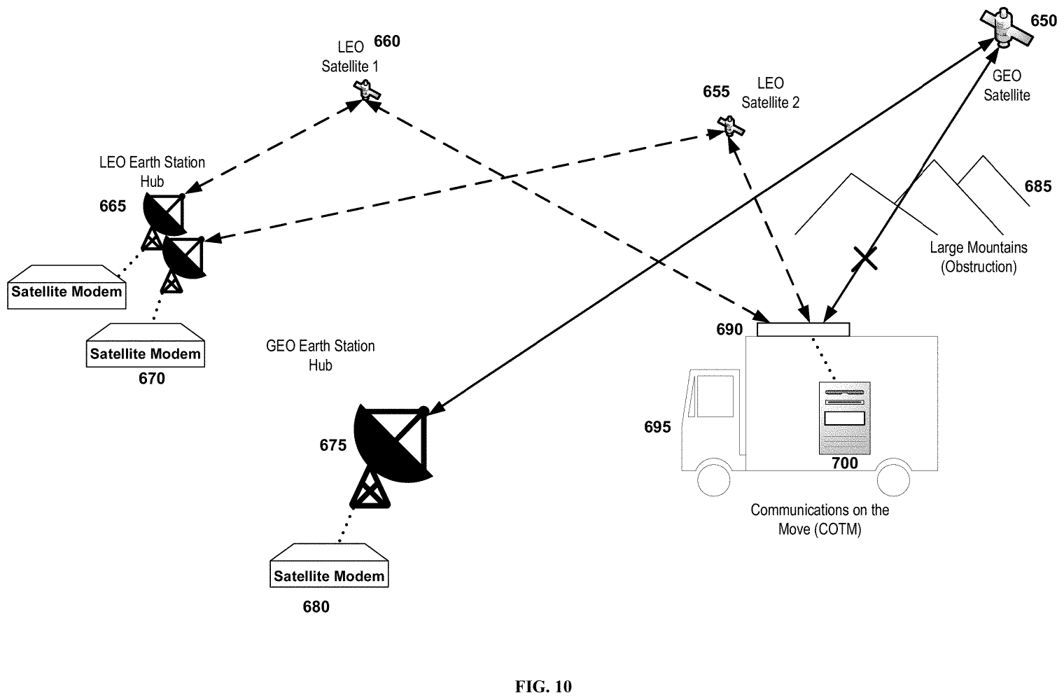

An advantage of the described invention is the adaptability inputting blockage conditions into the beam switching processing module. FIG. 10 demonstrates that even though the GEO satellite 650 has a lower operating cost, the terrain will impact the transmission of the terminal to the GEO satellite 650 while passing from the satellite to the terminal based on the trajectory of the communications on the move (COTM) 695 through an area with mountains 685, e.g., “significant blockages.” The communication network and methods described herein comprising a HPC-based satellite modem configured with machine learning capability 700 provides a recommendation to move the service form a lower cost GEO satellite 650 to a more expensive service provided by LEO satellite 1 660 and LEO satellite 2 665, but in the end providing an overall more reliable service during the path of travel. When the blockage conditions 685 are no longer an impact to the service, the HPC-based satellite modem configured with machine learning capability 700 may direct the service back to the primary GEO satellite 650.

Accordingly, the systems and methods described herein provide greater flexibility and resilience to a communication network, e.g., SATCOM network, by the utilizing a HPC-based satellite modem configured with machine learning capability 700 that receives, processes, and produces recommendations on network management based on dynamic, real-time, data on weather, terrain, geography, satellite positions, cost of satellite service, transmission times, obstructions to communications, wavelengths, signal strengths, and combinations thereof, gathered from disparate static and dynamic databases. The machine learning system accepts data from a plurality of input sources of information, process the data via the machine learning infrastructure using a structure known as “reinforcement learning” where a given set of bounds are established, and the algorithm is allowed to move through the bounds (limitations) with the goal of finding a successful communications path, while looking at future events with an attempt to ensure the link is firstly solvable, efficient as possible, reliable, and sustainable.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only and is not intended to limit the scope of the present invention, which is limited only by the appended claims.

Although the invention has been described in some detail by way of illustration and example for purposes of clarity of understanding, it should be understood that certain changes and modifications may be practiced within the scope of the appended claims. Modifications of the above-described modes for carrying out the invention that would be understood in view of the foregoing disclosure or made apparent with routine practice or implementation of the invention to persons of skill in electrical engineering, telecommunications, computer science, and/or related fields are intended to be within the scope of the following claims.

All publications (e.g., Non-Patent Literature), patents, patent application publications, and patent applications mentioned in this specification are indicative of the level of skill of those skilled in the art to which this invention pertains. All such publications (e.g., Non-Patent Literature), patents, patent application publications, and patent applications are herein incorporated by reference to the same extent as if each individual publication, patent, patent application publication, or patent application was specifically and individually indicated to be incorporated by reference.

We claim:

1. A communication network comprising
a ground station comprising a modem communicatively coupled to
at least one communications platform communicatively coupled to
at least one communications terminal system comprising
a high-performance computer (HPC)-based satellite modem configured with machine learning capability,
access to a plurality of repeating relays,
optionally access to a plurality of regenerative relays with on-board processing, and
a directional antenna requiring pointing to at least one aerial or space communications platform for connectivity.

2. The system of claim 1, wherein the communications terminal system is a fixed terminal, Communications on the Move (COTM) system, Communication on the Pause (COTP), or a combination thereof.

3. The system of claim 1, wherein the communications terminal system further comprises being coupled to a terminal with a plurality of input parameters to enable decisions to be made based on an initial starting location.

4. The system of claim 1, wherein the ground station comprises a ground station for receiving communications from a repeating relay, regenerative relays with on-board processing, or a combination thereof, from one or a plurality of repeating relays.

5. The system of claim 1, wherein the communications platform is an aerial communications platform, space communications platform, or a combination thereof.

6. The system of claim 5, wherein the space communications platform is a LEO satellite gateway, GEO satellite gateway, or MEO satellite gateway acting as a communications end point or a communications relay.

7. The system of claim 5, wherein the aerial communications platform comprises a satellite, airplane, balloon, drones, helicopters, airships (zeppelins), rockets, and combinations thereof, acting as a communications end point or a communications relay.

8. The system of claim 1, wherein the communications terminal system is configured to process a plurality of input parameters to enable decisions to be made based on an initial starting location of the communications platform.

9. The system of claim 1, wherein the communications terminal system configured to make a recommendation on configuration of the communication network to optimize communications.

10. The system of claim 1, wherein the communications terminal system is further configured to execute a recommendation to reconfigure the communications network to optimize communications.

11. The system of claim 1, wherein the communication terminal is a fixed terminal.

12. The system of claim 1, wherein the communications on the move (COTM) comprises a vehicle, an HPC-based satellite modem configured with machine learning capability, an antenna, and is mobile.

13. The system of claim 1, wherein the communication on the pause (COTP) system comprises a vehicle, a HPC-based satellite modem configured with machine learning capability, an antenna, and is mobile.

14. The system of claim 12, wherein the vehicle is a surface vehicle, an airborne vehicle, or submersible vehicle.

15. The system of claim 1, wherein the machine learning capability comprises a machine learning system.

16. The system of claim 1, wherein the machine learning system is trained using historic data, current data, optionally accessed from static and/or dynamic databases, or a combination thereof.

17. The system of claim 1, wherein the machine learning system comprises a high-performance computer existing as a central processing unit and combined with a hardware acceleration device, while operating in a heterogeneous fashion.

18. The system of claim 1, wherein the machine learning system is configured to access and/or process data from static databases, dynamic databases, and combinations thereof.

19. The system of claim 1, wherein the machine learning system is configured to access and/or process data comprising weather data, terrain data, video data, geographic data, traffic data, satellite cost data, crowd-sourced data, signal strength, satellite positions, cost of satellite service, transmission times, obstructions to communications, wavelengths, and combinations thereof.

20. The system of claim 1, wherein the machine learning system is configured to access and/or process data dynamic data, optionally updated in real-time, and static data, optionally sporadically updated.

21. The system of claim 1, wherein the machine learning system is configured to access and/or process data stored on public databases, private databases, databases managed by government agencies, and combinations thereof.

22. The system of claim 1, wherein the machine learning system uses an algorithm selected from the group consisting of linear regression, logistic regression, decision tree, support vector machine (SVM), Naïve Bayes, k-nearest neighbors (kNN), K-means, Random Forest, Dimensionality Reduction Algorithms, Gradient Boosting algorithms, or an ensemble thereof.

23. The system of claim 22, wherein the Gradient Boosting algorithm is gradient boosting machine (GBM), extreme gradient boost (XGBoost), LightGBM, CatBoost, or an ensemble thereof.

24. The system of claim 1, wherein the machine learning system is a reinforcement learning system.

25. The system of claim 1, wherein the machine learning system, optionally a reinforcement learning system, uses an algorithm selected from the group consisting of a Monte Carlo algorithm, Q-learning algorithm, State-action-reward-state-action (SARSA) algorithm, Q-learning—lambda algorithm, SARSA-lambda algorithm, DQN (Deep Q Network) algorithm, DDPG (Deep Deterministic Policy Gradient) algorithm, A3C (Asynchronous Advantage Actor-Critic Algorithm) algorithm, NAF (Q-learning with normalized Advantage functions) algorithm, TRPO (Trust Region Policy Optimization) algorithm, PPO (Proximal Policy Optimization) algorithm, TD3 (twin delayed deep deterministic policy gradient) algorithm, SAC (Soft Actor-Critic) algorithm, or an ensemble thereof.

26. The system of claim 1, wherein the machine learning system, optionally a reinforcement learning system, is trained on data from static databases, dynamic databases, and combinations thereof.

27. The system of claim 1, wherein the machine learning system, optionally a reinforcement learning system, is trained on data comprising weather data, terrain data, video data, geographic data, traffic data, satellite cost data, crowd-sourced data, signal strength, satellite positions, cost of satellite service, transmission times, obstructions to communications, wavelengths, and combinations thereof.

28. The system of claim 1, wherein the machine learning system, optionally a reinforcement learning system, is trained on data comprising dynamic data, optionally updated in real-time, and static data, optionally sporadically updated.

29. The system of claim 1, wherein the machine learning system, optionally a reinforcement learning system, is trained on data stored on public databases, private databases, databases managed by government agencies, and combinations thereof.

30. A method for optimizing a communication network comprising accessing data at a communications terminal system comprising a high-performance computer (HPC)-based satellite modem configured with machine learning capability,
processing the data using a machine learning system, and
generating a recommendation for configuration of a communications network.

31. A method for sending a message via a communications network comprising receiving a message at a ground station comprising a modem communicatively coupled to
at least one communications platform communicatively coupled to
at least one communications terminal system comprising
a high-performance computer (HPC)-based satellite modem configured with machine learning capability,
access to a plurality of repeating relays,
optionally access to regenerative relays with on-board processing, and
a directional antenna requiring pointing to at least one aerial or space communications platform for connectivity,
determining a communications network for the message comprising
accessing data, the communications terminal system comprising a high-performance computer (HPC)-based satellite modem configured with machine learning capability,
processing the data using a machine learning system, and
generating a recommendation for configuration of a communications network,
sending the message across the recommended communications network configuration.
